(19) United States
(12) Patent Application Publication
(10) Pub. No.: US 2008/0181776 A1
(43) Pub. Date: Jul. 31, 2008

(54) Phase control structure for crank-connecting control disk

(76) Inventor: Aling Lai, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/699,564

(22) Filed: Jan. 30, 2007

(51) Int. Cl. B64C 11/30

(52) U.S. Cl. 416/108; 416/101

(57) ABSTRACT

A phase control structure for crank-connecting control disk has a control disk on a helicopter body. The control disk is connected with a crank assembly pivotally connected to the body. The crank assembly includes a connecting element, a first crank and a second crank. The connecting element, the first crank, and the second crank can pivotally rotate with respect to each other. When the control disk is pulled by a first or second pulling rod, the phase thereof can be achieved using the crank assembly. This can increase the precision in the motion of the helicopter.

### BACKGROUND OF THE INVENTION

1. Field of Invention

The invention relates to a phase control structure for the helicopter control disk and, in particular, to a structure for controlling the phase of a control disk using a crank assembly.

2. Related Art

In the control of helicopter, the cross disk is an important element for moving the helicopter forward/backward, upward/downward, and to the left/right. The model helicopter without a cross disk cannot be controlled to move forward/backward or sideways.

As shown in FIG. 8, the cross disk 41 is disposed on top of the helicopter body 4. Both sides in the front of the cross disk 41 are provided with a pulling rod 42, respectively. The rear part of the cross disk 41 is connected with another pulling rod 43. The front of the cross disk 41 is provided with a rod 411 that penetrates through a track 441 of a blocking element 44 on the body 4. To change the proceeding direction of the helicopter, the pulling rods 42 or the pulling rod 43 pulls the control disk 41 to make different orientation controls. In this case, the rod 411 moves ups and downs inside the track 441, thereby controlling the phase for changing the proceeding direction of the helicopter.

However, this technique still has some problems. When the rod 411 moves ups and downs inside the track 441, some gap is formed between the rod 411 and the track of the blocking element in order to it to move smoothly inside the track 441. However, the existence of the gap results in deviations in orientation controls. That is, the proceeding direction of the helicopter cannot be accurately controlled so that it may not fly in the desired direction.

### SUMMARY OF THE INVENTION

An objective of the invention is to provide a phase control structure for the crank-connecting control disk. The control disk is connected with a crank assembly. Through the connection of a crank, the phase is adjusted under the action of the control disk. This can achieve precision control in the proceeding direction of the helicopter.

To achieve the above objective, the invention includes:
a body;
a shaft, which vertically extends from the inside of the body to the outside above the body top;
a control disk, which is disposed on top of the body with the shaft penetrating through its center;
a first pulling rod, which is connected to the control disk with one end and to the body in the vicinity of the control disk;
two second pulling rods, which are provided on two opposite sides of the control disk in the vicinity of the body with their one ends connecting to the opposite sides of the control disk and their other ends connecting to the body in the vicinity of the body; and
a crank assembly, which includes a connecting element, a first crank, and a second crank, the connecting element being provided on one side of the control disk corresponding to the first pulling rod on the other side of the control disk, the outer side of the connecting element being pivotally connected with one end of the first crank, the other end of the first crank being pivotally connected with one end of the second crank, and the other end of the second crank being pivotally connected on the body;
wherein under the pulling of the control disk the connecting element drives the first crank and the second crank to move ups and downs in a pivotal way about an axis, and the axis is perpendicular to the connecting direction between the front and rear of the body so that the phase of the control disk is controlled by the crank assembly.

### BRIEF DESCRIPTION OF THE DRAWINGS

The invention will become more fully understood from the detailed description given herein below illustration only, and thus is not limitative of the present invention, and wherein:

FIG. 1 is a three-dimensional view of the invention disposed on a helicopter;

FIG. 2 is a three-dimensional enlarged view of the invention;

FIG. 3 is a schematic side view of the helicopter body;

FIG. 4 is a schematic front view of the helicopter body;

FIG. 5 is a schematic view showing how the crank assembly is driven by the control disk;

FIG. 6 is another schematic view showing how the crank assembly is driven by the control disk;

FIG. 7 is a schematic view of the invention with a different embodiment in the second crank; and

FIG. 8 is a schematic view of the conventional phase control structure and the cross disk.

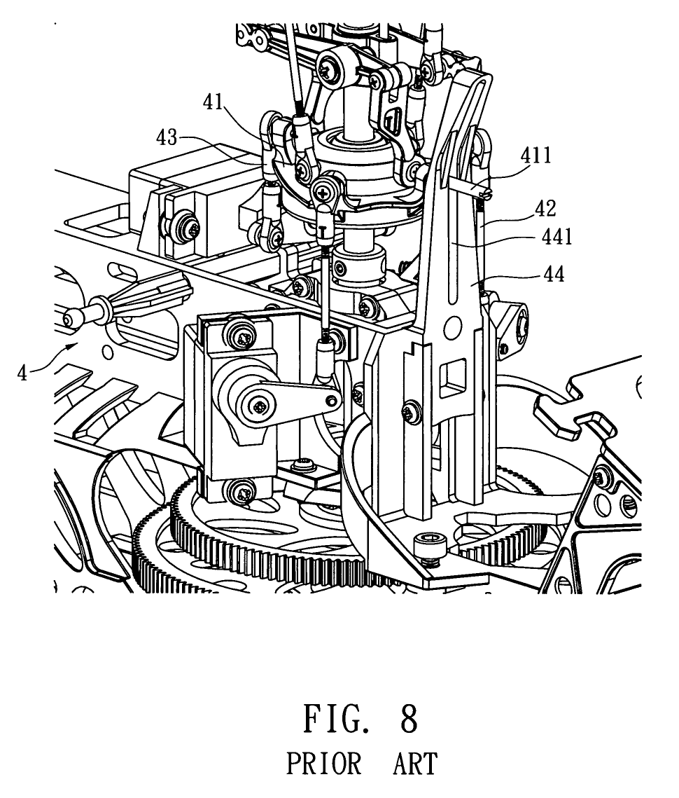

### DETAILED DESCRIPTION OF THE INVENTION

The present invention will be apparent from the following detailed description, which proceeds with reference to the accompanying drawings, wherein the same references relate to the same elements.

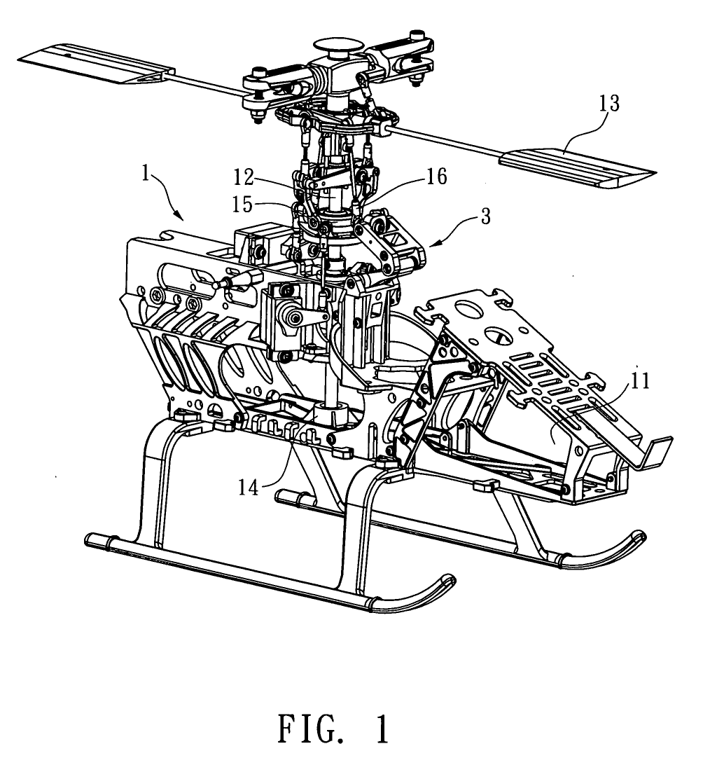

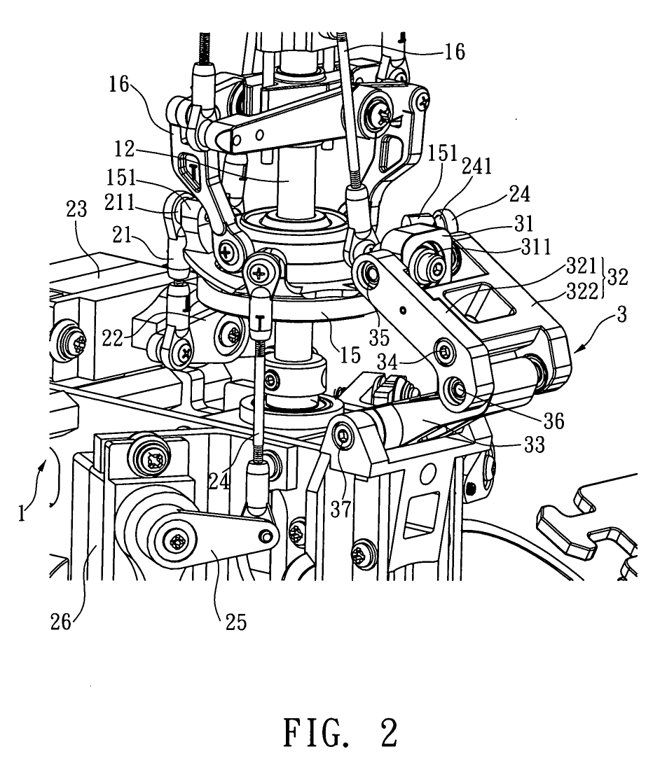

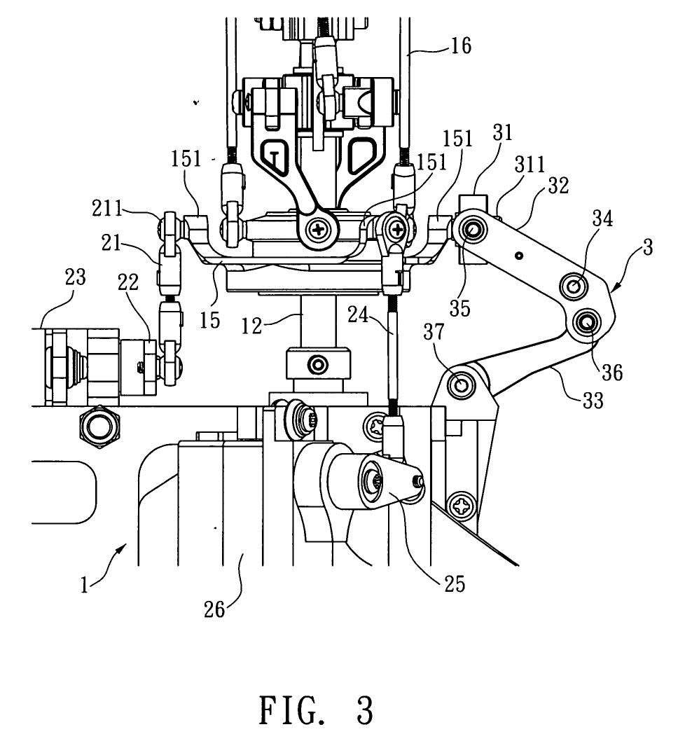

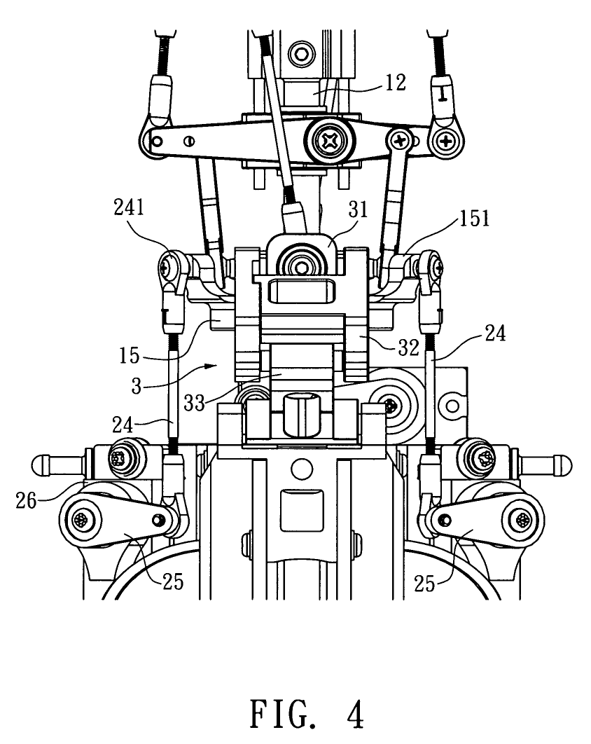

FIGS. 1 to 7 show embodiments of the invention. They are used for the purpose of explaining the invention, and should not be used to restrict the scope defined in the claims.

With simultaneous reference to FIGS. 1 to 4, the disclosed phase control structure for the crank-connecting control disk includes: a body 1, a rotatable shaft 12, a control disk 15, a first pulling rod 21, two pulling rods 24, and a crank assembly 3.

The body 1 in this embodiment refers in particular to a helicopter body. As shown in FIG. 1, the body 1 has a front end defined as the end with a space 11 and a rear end defined as the end far away from the space 11.

The rotatable shaft 12 is vertically disposed inside the body 1 and extends above the top of the body 1. The top end of the shaft 12 is connected with a stabilizing propeller 13. Its bottom end is inside the body 1 and connected to a driving device 14 for driving the shaft 12.

The control disk 15 is above the top of the body 1. The shaft penetrates through the center of the control disk 15. Generally speaking, the control disk 15 refers to the cross disk for controlling the proceeding direction of the helicopter. The control disk 15 is usually provided with several controlling rods 16, which are connected to the stabilizing propeller 13 for controlling the control disk 15 and the stabilizing propeller 13.

One end of the first pulling rod 21 is connected to the control disk 15, in the vacinity of the rear end of the body 1. The other end is connected to the body 1, in the vicinity of the control disk. In this embodiment, the other end can also be connected to one end of a horizontally disposed swing arm 22. The other end of the swing arm 22 is connected to a driving element 23 disposed inside the body 1. A ball joint 211 is provided at the joint between the two ends of the first pulling rod 21 and the control disk 15 and the swing arm 22, respectively.

The two second pulling rods 24 are disposed on two opposite sides of the control disk in the front of the body 1. The two second pulling rods 24 are connected to two opposite sides of the control disk 15 using the ends in the same direction, and to the body 1 in the vicinity of the control disk 15 using the other ends. The other ends of the second pulling rods 24 are connected with a horizontal swing arm 25, respectively. The other end of the swing arm 25 is connected with a driving unit disposed on the body 1. Each end of each of the second pulling rods 25 are provided with a ball joint 241 at the joint with the control disk 15 and the swing arm 25, respectively.

The crank assembly 3 includes a connecting element 31, a first crank 32, and a second crank 33. The connecting element 31 is disposed at one end of the control disk 15 in the vicinity of the body 1. A connection portion 311 penetrates through the center of the connecting element 31. The connection portion 311 allows the connecting element 31 to connect with the control disk 15. The connecting element 31 also corresponds to the first pulling rod 21 on the other side of the control disk. The outer sidewall of the connecting element 31 is pivotally connected with one end of the first crank 32. The other end of the first crank 32 is pivotally connected with one end of the second crank 33. The other end of the second crank 33 is pivotally connected with the body 1. The pivotal joint between the first crank 32 and the second crank 33 is far away from the shaft 12.

In this embodiment, the first crank 32 includes a first element 321 and a second element 322. The first and second elements 321, 322 are locked using a first fixing element 34 penetrating through them. The assembled first and second elements 321, 322 are disposed on the two horizontally symmetric sides of the connecting element 31 using the ends closer to the control disk 15. The other ends are pivotally connected to one end of the second crank 33. In practice, a second fixing element 35 us pivotally connected to the two sides of the first crank 32 horizontally symmetric about the connecting element 31. The first crank 32 and the second crank 33 are connected via a third fixing element 36. The second crank 33 and the body 1 are connected via a fourth fixing element 37.

A protruding portion 151 is provided at the joint between the control disk 15 and the first pulling rod 21 and the joint between the two second pulling rods 24 and the connecting element 31, respectively. They are provided to connect the ball joints 211 of the first pulling rod 21, the ball joints of the second pulling rod 24, and the connection portion 311 of the connecting element 31.

Besides, the connecting element 31 driven by the control disk 15 moves the first crank 32 and the second crank 33 ups and downs. The axial direction about which they perform pivotal motions is perpendicular to the direction connecting the front and rear ends of the body 1. Therefore, the crank assembly 3 can control the phase of the control disk 15.

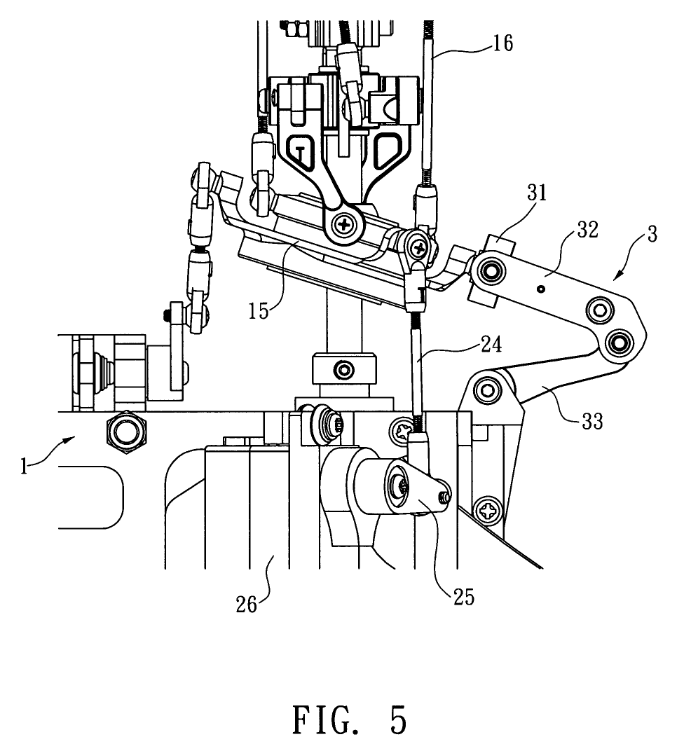

Please refer to FIG. 5 for the actual operation of the invention. When the helicopter flies forward, the two driving units 26 provided under the two second pulling rods 24 drive the two swing arms 25. The two swing arms 25 pull the second pulling rods 24 downward, so that the end of the control disk 15 toward the front of the body 1 moves downward. The controlling rods 16 connecting the control disk 15 and the stabilizing propeller 13 changes the flying direction. In particular, the connecting element 31 of the crank assembly 3 is driven by the downward motion of the front end of the control disk 15. At the same time, the pivotal motions of the connecting element 31, the first crank 32, and the second crank 33 in the vertical linear direction enable a precision control over the phase of the control disk 15.

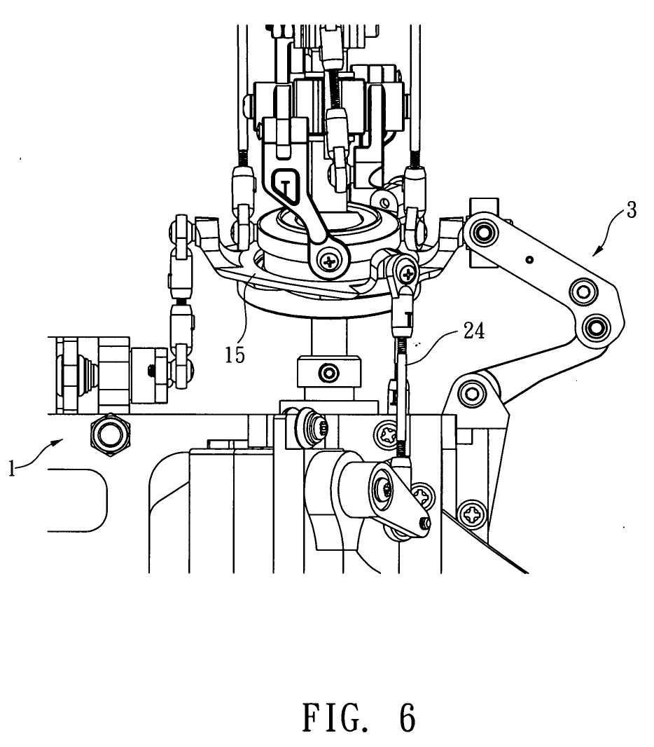

With reference to FIG. 6, suppose the helicopter is to fly to the right. The second pulling rod 24 connected with the control disk and on the right to the front end of the body pulls the control disk 15 downward to adjust its proceeding direction. Of course, the crank assembly 3 is also driven by the control disk. The pivotal motion of the crank assembly in the vertical linear direction makes the phase control of the control disk 15 more precise.

In summary, the invention uses a crank assembly as a mechanism to adjust the phase of the control disk while a helicopter adjusts its proceeding direction. This achieves precision control of the helicopter's proceeding direction and reduces shifting errors thereof.

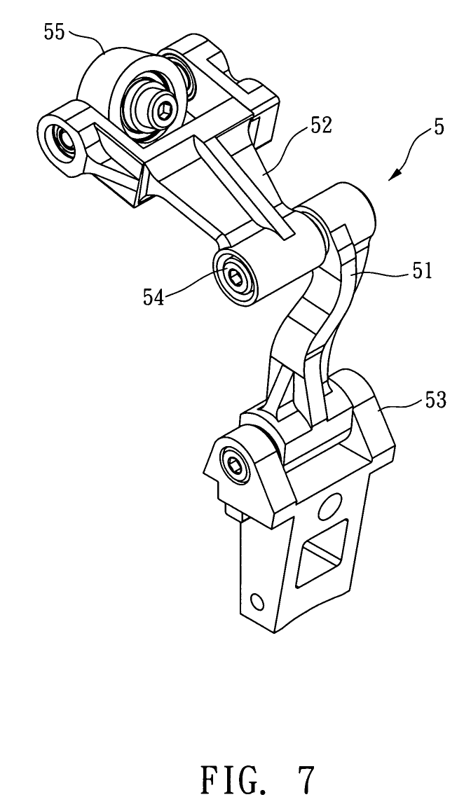

Moreover, the disclosed crank assembly 5 has other embodiments. As shown in FIG. 7, the second crank 51 of the crank assembly 5 is curved, with the curved end pivotally connected with the other end of the first crank 52. The other end of the second crank 51 is pivotally connected with a fixing element 53 fixed on the body 1 (not shown). The first crank 52 and the second crank 51 are connected via a fifth fixing element 54. The first crank 52 is also pivotally connected with two symmetric sides of the connecting element 55 using its one end. The connecting element 55 also connects to the disclosed control disk and has a round shape in this embodiment.

This embodiment illustrates that the disclosed crank assembly has various different structures. All of them can achieve the phase control of the control disk.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A phase controlling structure for a crank-connecting control disk, comprising:
a body;
a shaft, which vertically extends from the inside of the body to the outside above the body top;
a control disk, which is disposed on top of the body with the shaft penetrating through its center;
a first pulling rod, which is connected to the control disk with one end and to the body in the vicinity of the control disk with the other end;
two second pulling rods, which are provided on two opposite sides of the control disk in the vicinity of the body with their one ends connecting to the opposite sides of the control disk and their other ends connecting to the body in the vicinity of the body; and
a crank assembly, which includes a connecting element, a first crank, and a second crank, the connecting element being provided on one side of the control disk corresponding to the first pulling rod on the other side of the control disk, the outer side of the connecting element being pivotally connected with one end of the first crank, the other end of the first crank being pivotally connected with one end of the second crank, and the other end of the second crank being pivotally connected on the body;
wherein under the pulling of the control disk the connecting element drives the first crank and the second crank to move ups and downs in a pivotal way about an axis, and the axis is perpendicular to the connecting direction between the front and rear of the body so that the phase of the control disk is controlled by the crank assembly.

2. The phase controlling structure for a crank-connecting control disk of claim 1, wherein the other end of the first pulling rod is connected to one end of a swing arm whose other end is connected with a driving unit disposed on the body.

3. The phase controlling structure for a crank-connecting control disk of claim 2, wherein the two ends of the first pulling rod are provided with a ball joint at the joints with the control disk and the swing arm, respectively.

4. The phase controlling structure for a crank-connecting control disk of claim 1, wherein the two second pulling rods are connected to one end of a swing arm using the other ends in the same direction and the other end of the swing arm is connected to a driving unit disposed on the body.

5. The phase controlling structure for a crank-connecting control disk of claim 4, wherein the two ends of each pulling rod are provided with a ball joint at the joints with the control disk and the swing arm, respectively.

6. The phase controlling structure for a crank-connecting control disk of claim 1, wherein the first crank includes a first element and a second element that are assembled using a first fixing element, one ends of the assembled first and second elements are pivotally connected to two symmetric sides that are horizontal with respect to the connecting element, and the other ends are pivotally connected to one end of the second crank.

7. The phase controlling structure for a crank-connecting control disk of claim 1, wherein a second fixing element is provided on two symmetric sides of the first crank that are horizontal with respect to the connecting element, the first crank and the second crank are pivotally connected using a third fixing element, and the second crank and the body are pivotally connected using a fourth fixing element.

8. The phase controlling structure for a crank-connecting control disk of claim 1, wherein the center of the connecting element is provided with a connection portion for the connecting element and the control disk to connect with each other.

9. The phase controlling structure for a crank-connecting control disk of claim 1, wherein the joint between the first crank and the second crank is away from the shaft.

10. The phase controlling structure for a crank-connecting control disk of claim 1, wherein the control disk is formed with a protruding portion at joints with the first pulling rod, the two second pulling rods, and the connecting element for connections.

11. The phase controlling structure for a crank-connecting control disk of claim 1, wherein the second crank is curved and the curved end is pivotally connected with the other end of the first crank.

12. The phase controlling structure for a crank-connecting control disk of claim 11, wherein the first crank and the second crank are connected via a fifth fixing element.
